(19) United States
(12) Patent Application Publication
(10) Pub. No.: US 2005/0243302 A1
(43) Pub. Date: Nov. 3, 2005

(54) Two dimensional range-imaging

(76) Inventors: Bedabrata Pain, Los Angeles, CA (US); Bruce Hancock, Altadena, CA (US)

Correspondence Address: FISH & RICHARDSON, PC, 12390 EL CAMINO REAL, SAN DIEGO, CA, 92130-2081, US

(21) Appl. No.: 11/040,217

(22) Filed: Jan. 20, 2005

Related U.S. Application Data
(60) Provisional application No. 60/538,002, filed on Jan. 20, 2004.

(51) Int. Cl. G01C 3/08

(52) U.S. Cl. 356/5.15; 356/5.01; 356/4.03

(57) ABSTRACT

A two-dimensional range-imaging system is capable of transmitting light from a source into a field of view and focusing return portions of the light, reflected off targets in the field of view, onto a two-dimensional array of photodetectors. The photodectectors convert the return portions of light into electric signals that are compatible with a solid state circuit. Each electric signal is combined with a one or more reference signals to indicate a distance between the source and an associated target.

### CROSS REFERENCE TO RELATED APPLICATIONS

The application claims the benefit of U.S. Provisional Application No. 60/538,002, filed Jan. 20, 2004.

### STATEMENT OF GOVERNMENT INTEREST

The U.S. Government has a paid-up license in this invention and the right in limited circumstances to require the patent owner to license others on reasonable terms as provided for by the terms of contract No. NAS7-1407 awarded by the National Aeronautics and Space Administration (NASA).

### FIELD OF THE DISCLOSURE

This disclosure relates to range imaging systems and more particularly to two-dimensional range imaging.

### BACKGROUND

Generally, range-imaging systems can be used to create three-dimensional representations of a particular scene. The scene may include multiple targets positioned randomly within a particular field of view. The three-dimensional representation may include distances between one object (such as an unmanned vehicle) and another object (such as an obstacle in the path of the unmanned vehicle). In such an instance, a range imaging system may provide information to the navigation system of the unmanned vehicle to assist the system in making decisions regarding navigation, object detection and avoidance.

Range imaging systems also may be used to assist aircrafts and spacecrafts to land safely and may be used in various applications related to robotic navigation.

### SUMMARY

One aspect of the disclosure provides a method that includes transmitting light from a source into a field of view and focusing return portions of the light, reflected off targets in the field of view, onto a two-dimensional array of photodetectors. The method includes using the photodetectors to convert the return portions of light into electric signals that are compatible with a solid-state circuit. The method further includes combining each electric signal with a first reference signal to indicate a distance between the source and an associated target. In certain embodiments, combining each electric signal with the first reference signal may include multiplying each electric signal by the first reference signal and integrating a resulting product over time.

The indicated distance between the source and the associated target may be based on a first phase relationship between the return portions of the light and a first reference signal. Certain embodiments may include generating the first reference signal at the same time that the light is transmitted. The method also may include calculating the distances between the source and each target based on the indications from the solid-state circuit. A map may be created to represent the calculated distances between the source and each target in the field of view. Indicating the distance between the source and each target may include identifying a phase relationship between each electric signal from each photodetector and the first reference signal.

In certain embodiments, determining the distance between the source and each target may include generating a current that is proportional to a product of the electric signals and the first reference signal. Determining the distance between the source and each target also may include integrating the current with respect to time. Determining the distance between the source and each target may include integrating the current with a capacitor. Focusing the return portion of light may include passing the return portion of light through an optical lens coupled to the array of photodetectors.

The method may include identifying a first phase relationship between a converted electric signal and the first reference signal, identifying a second phase relationship between the converted electric signal and a second reference signal and identifying a third phase relationship between the converted electric signal and a third reference signal. Such embodiments may also include combining the first phase relationship, the second phase relationship and the third phase relationship to indicate a distance between an associated source and an associated target. The method may include generating the first reference signal, the second reference signal and the third reference signal such that, for example, the first reference signal, the second reference signal and the third reference signal are phase shifted relative to each other.

The light may be generated with a laser source or a light emitting diode. The light may be diffused into the field of view with an optical lens coupled to the source. The transmitted light may be a pulse or a sinusoidal waveform.

Determining the distance between the source and each target may be based on a phase relationship between the return portion of the light and a coarse-tuning reference signal, wherein the first reference signal is a periodic waveform having a first frequency and the coarse-tuning reference signal has a coarse-tuning frequency that is lower than the first frequency.

Another aspect provides an apparatus including a light source adapted to transmit light into a field of view, an optical receiver coupled to the light source adapted to receive return portions of the light, reflected off targets in the field of view and a solid state, two-dimensional array of detection circuits. Each detection circuit includes a photodetector adapted to convert an associated return portion of light into an electric signal compatible with solid state circuitry and a solid state circuit including a phase detector adapted to combine the electric signal with a first reference signal to indicate a distance between the source and an associated target. The distance indicated by each phase detector may be based on a first phase relationship between the return portion of transmitted light and the first reference signal.

The optical receiver may be adapted to focus each return portion of light onto an associated photodetector in the array of phase detectors. Each photodetector may be adapted to convert a focused return portion of light into an electric signal that is compatible with solid-state circuitry. A reference signal generator may be provided in the apparatus to generate the first reference signal.

According to one embodiment, each phase detector includes more than one multiplication transistor coupled to an output terminal of an associated photodetector. Each of the multiplication transistors may be adapted to receive an electric signal from the associated photodiode. Also, each multiplication transistor may be adapted to receive the first reference signal, and to output a current that is approximately proportional to a product of the associated electric signal and the first reference signal.

Certain embodiments may include capacitors in each phase detector. Each capacitor may be coupled to an output terminal of an associated multiplication transistor. Each capacitor may be adapted to collect a charge that corresponds to an integration of an output signal from the associated multiplication transistor.

The phase detector may be adapted to identify a first phase relationship between a converted electric signal and the first reference signal, identify a second phase relationship between the converted electric signal and a second reference signal and identify a third phase relationship between the converted electric signal and a third reference signal. The phase detector may be further adapted to combine the first phase relationship, the second phase relationship and the third phase relationship to indicate a distance between the source and an associated target. An electronic oscillator may be provided to generate the first reference signal, the second reference signal and the third reference signal. According to certain implementations, the first reference signal, the second reference signal and the third reference signal are phase shifted relative to each other.

In some embodiments, the phase detectors are further adapted to indicate a second phase relationship between an associated electric signal and the second reference signal and to indicate a third phase relationship between the associated electric signal and the third reference signal.

A processing unit may be provided to combine the first phase relationship, the second phase relationship and the third phase relationship to determine the distance to each target. Particular embodiments include circuitry including complementary metal oxide semiconductor (CMOS)-based circuitry with PMOS and NMOS transistors. The light source may be a laser source or a light emitting diode.

Certain implementations include an optical lens coupled to the light source and adapted to diffuse the light transmitted into the field of view. The light source may be adapted to generate a light pulse or a sinusoidal waveform.

An operator interface may be provided to display a map representing the distances between the source and each target in the field of view based on the indications from the phase detectors.

The apparatus may include a coarse-tuning reference signal generator coupled to the detector array to generate a coarse-tuning signal for modulating a multiplication transistor.

Implementing the techniques and concepts disclosed herein may result in one or more advantages. For example, a compact range-imaging system may be provided that is capable of capturing information indicating a snapshot two-dimensional range-image of a scene. The speed at which such a two-dimensional range-image can be captured may be increased, and, in some cases, may approximate video rates. The range-imaging circuitry may be implemented using largely standard, off-the-shelf and inexpensive circuitry, which may be integrated into a small package. A relatively small amount of power may be needed for such circuitry to operate. Additionally, accuracy in calculating distances to targets in a field of view may be improved.

Range-imaging systems incorporating the concepts disclosed herein may enhance the operation of autonomous navigation systems, such as are used, for example, in unmanned rovers, aerobots or other robotic devices. Aircraft descent/landing systems that incorporate the concepts disclosed herein also may realize enhanced operational capabilities. Such descent/landing systems may be used, for example, in spacecrafts. Implementing certain features disclosed herein may enhance the operational capabilities of path-planning and obstacle detection and avoidance systems.

Other features and advantages may be apparent from the following detailed description, the accompanying drawings and the claims.

### BRIEF DESCRIPTION OF THE DRAWINGS

FIG. 1 is a flow diagram for a method of creating a range map.

FIG. 2 illustrates a system block diagram of a range imaging system.

FIG. 3 illustrates a circuit diagram of a range imaging system.

FIGS. 4A-4C illustrate waveforms at multiplication transistors.

FIG. 5 is a chart of measured output charge vs. pulse delay.

FIG. 6 is a chart of calculated voltage vs. pulse delay.

FIG. 7 includes two charts showing calculated range of each pixel in an array.

### DETAILED DESCRIPTION

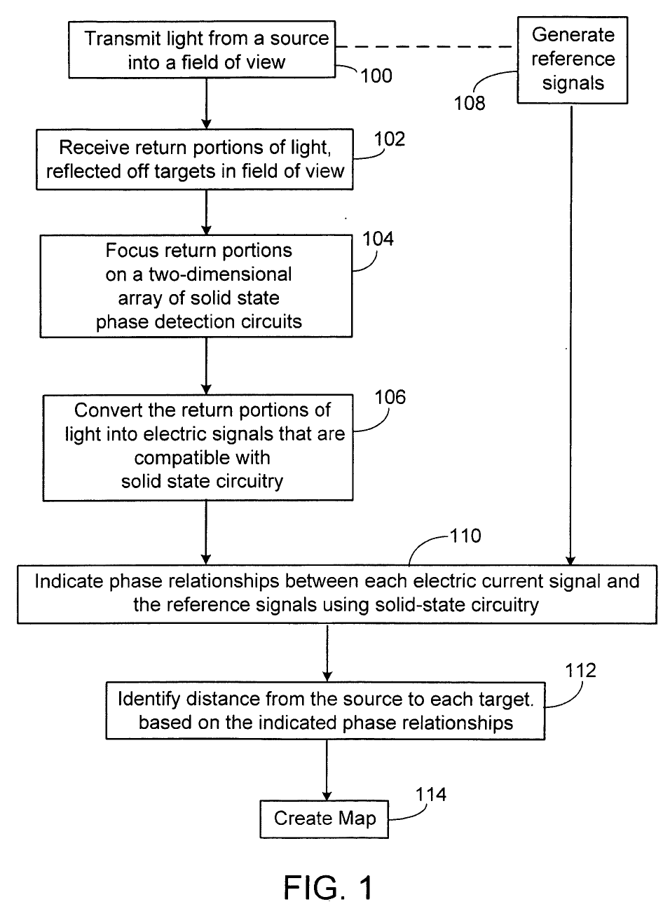

FIG. 1 is a flow diagram detailing a method for creating a map of three-dimensional features associated with targets in a field of view.

The illustrated method includes transmitting 100 light from a source into a field of view. The light source may be, for example, a laser or a light emitting diode (LED). According to one embodiment, the transmitted light is a pulse of light. According to another embodiment, the transmitted light is a sinusoidal waveform. The transmitted light may be diffused to illuminate a broad field of view. The term “field of view” includes any area, scene or landscape of which it might be desirable to create a three dimensional map. The field of view may be as an approximately circular area that is defined by an angle that extends from the light source outward. In certain implementations, the angle may be between 0° and 180°. In other embodiments, the angle may be between approximately 10° and 90°. In yet other embodiments, the angle may be between approximately 15° and 60°.

In many instances, multiple targets (e.g., variations in topology, contours on a surface, discrete objects, physical depressions, etc.) will be present within the “field of view.” Targets may be any surface in the field of view that can reflect light back toward the source. The transmitted light is reflected off one or more of those targets, with portions of the reflected light returning to the light source. Return portions of the transmitted light, reflected off the targets, are received 102 at an optical receiver near the light source. The optical receiver focuses 104 the return portions of light upon a two-dimensional array of photodiodes, so that each photodiode in the array responds to the portion of light incident thereupon. Each photodiode converts 106 the respective portion of light incident thereupon into an electric signal. In one implementation, the electric signals generated by the photodiodes are electrical currents that are approximately proportional to the energy of the return portion of light incident on the photodiode. The electric signals may be compatible with a solid-state circuit. Solid-state circuits may include, for example, metal-oxide semiconductor field effect transistors, other transistors, and other circuit elements, such as resistors, capacitors, etc.

The illustrated method also includes generating 108 a reference signal. This may be accomplished by a signal generator coupled to the light source. Generation 108 of the reference signal may begin at approximately the same time that the light is transmitted 100 from the source. In one implementation, the reference signal is a periodic signal, such as a sinusoidal waveform. In another implementation, the reference signal is an electric pulse having a duration similar to the duration of the light pulse. If the reference signal is periodic, then generation 108 may continue at least until the return portions of light are received 102 at the optical receiver. As discussed in further detail below, certain embodiments may include generating multiple reference signals.

After converting 106 the return portions of light into respective electric signals, the illustrated method includes identifying 110 a phase relationship between each of those electric signals and the reference signal (or signals) generated at 108. The phase relationships may be determined, for example, by comparing the waveforms associated with each electric signal with a voltage waveform associated with the reference signal.

According to the illustrated embodiment, the distance between the source and each target is calculated 112 based on the identified phase relationship. As will be readily understood by one of ordinary skill in the art, such calculations are possible, because each phase relationship is dependent on the distance between the source and an associated target.

As discussed in further detail below, some embodiments include taking steps to reduce the effects of background illumination, target albedo and electric noise, such as common-mode noise in solid state circuitry in the determination of distances between the source and each target. Other signal refinement and filtering techniques may be implemented in particular instances.

The illustrated method includes creating 114 a map that describes three-dimensional features of targets within the field of view. The three-dimensional features may include, for example, distances from the source to each of the targets in the field of view. Data from the three-dimensional map may be presented in any convenient format, for example, in tabular form, in the form of a two-dimensional perspective-view drawing of the targets or as a snapshot range map. Other suitable formats for presenting data related to three-dimensional images will be understood by one of ordinary skill in the art.

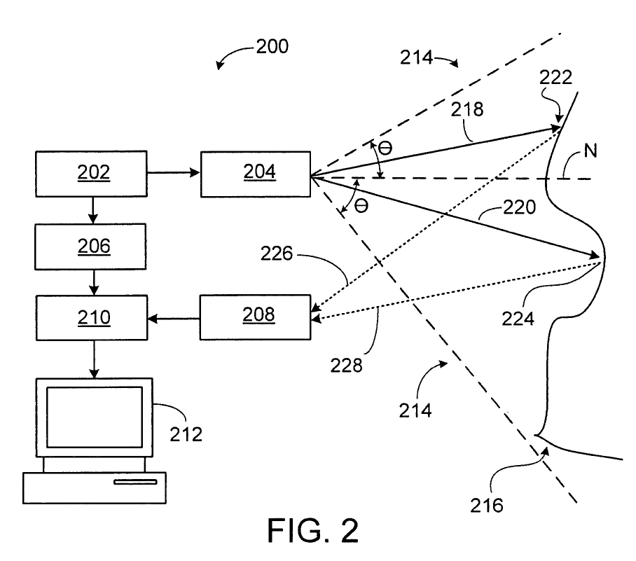

As shown in FIG. 2, a range-imaging system 200 may include a light source 202, an optical diffuser 204, a reference signal generator 206, an optical receiver 208, a detector array 210 and an operator interface 212. In one embodiment, detector array 210 includes circuitry to convert incident light into an electric signal and phase detection circuitry. A dashed line (identified by “N” in FIG. 2) extends from the optical diffuser in a direction that is approximately perpendicular to a front surface of the optical diffuser. Dashed lines that define an inner angle relative to line “N”, identified as θ in the figure, identify a field of view 214 associated with the range-imaging system. A surface 216 of an object is located within the field of view 214. That surface 216 includes numerous “targets,” each of which is a particular point on a surface of an object. Accordingly, a particular object may include multiple targets. Indeed, as illustrated, each spot on the surface 216 may be classified as a “target.”

The light source 202 is adapted to transmit light into the field of view 214. In one embodiment, the light source is a laser adapted to transmit a pulse of laser light into the field of view 214. According to certain embodiments, the reference signal generator 206 may be adapted to provide a triggering signal to the light source 202. In such instances, the light source may be adapted to transmit light into the field of view only when triggered by the reference signal generator 206 to do so. The reference signal generator 206 may trigger the light source 202 in that manner at the same time that a reference signal (or reference signals) is generated. Alternatively, the light source 202 may be triggered to transmit light by some other means. In that instance, the reference signal generator 206 may be adapted to sense the transmission of light and to react accordingly, for example, by initiating generation of an associated reference signal.

According to the figure, the optical diffuser 204 is positioned proximate the light source in such a manner that any light generated by the light source passes through the optical diffuser 204 before entering the field of view 214. The optical diffuser 204 may influence the generated light to spread out and cover a wide area (i.e., the field of view). Alternatively, the optical diffuser may be arranged to focus the transmitted light into a limited field of view, limited to cover only a particular area of interest. The optical diffuser may be, for example, an optical lens coupled to the light source 202.

As illustrated, for example, by arrows 218, 220, the transmitted light travels from the optical diffuser 204 to various targets (e.g., 222, 224) located within the field of view 214. Return portions of the transmitted light are reflected off various targets (e.g., 222, 224) and travel back toward the range-imaging system. Dotted arrows 226, 228 indicate the return portions of light. Although only two return portions (226, 228) are illustrated, one of ordinary skill in the art will recognize that a return portion of light may be reflected off each target with the field of view (at least within a particular distance of the range-imaging system).

As illustrated, the optical receiver 208 at the range-imaging system 200 receives the return portions of light (e.g., 226, 228). The optical receiver 208 may be an optical lens preferably coupled to the detector array 210 and to the light source 202. The optical receiver 208 is adapted to focus the return portions (e.g., 226, 228) of light onto the detector array 210.

A reference signal generator 206 is shown coupled between the light source 202 and the detector array 210. In one implementation, the reference signal generator 206 is an electronic local oscillator. In certain embodiments, the reference signal generator 206 is adapted to generate an electric reference signal that is compatible with solid-state circuitry, such as complementary metal-oxide semiconductor (CMOS) circuitry. Examples of reference signals include pulse-type signals, ramp signals, and periodic waveforms, such as square-wave or sinusoidal waveforms. The illustrated reference signal generator 206 may be triggered to begin generating an appropriate reference signal at substantially the same time that the light source 202 transmits light toward the optical diffuser 204. As shown, the reference signal generator 206 provides the generated reference signal into the detector array 210.

The detector array 210, which is described below in further detail, is adapted to determine a distance between the light source 202 and each target (e.g., 222, 224) within the field of view 214 of the range-imaging system 200. The detector array 210 includes several photodiodes arranged as an array. Each photodiode is adapted to convert a part of the return portions of light into an associated electric signal. In one embodiment, the electric signals are compatible with solid-state circuits. Each electric signal may be compared to the reference signal by an associated phase detection circuit. In a particular implementation, each of the associated phase detection circuits implements metal oxide semiconductor technology.

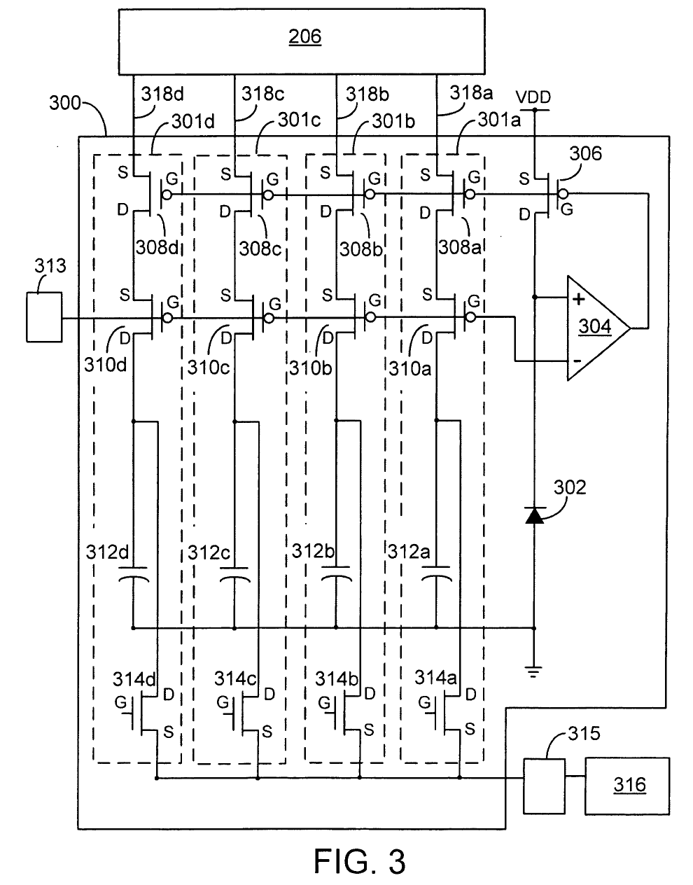

As shown in FIG. 3, a detection circuit 300 (“a pixel”) may include one photodiode 302 from a detector array (e.g., 210 of FIG. 2). A typical range-imaging system (e.g., 200 of FIG. 1) may include several such detection circuits 300. For example, a particular range-imaging system may include a detector array with 16,384 photodiodes arranged in an array of 128×128. In that instance, each of those photodiodes may be coupled to an associated, discrete detection circuit, such as detection circuit 300 (illustrated in FIG. 3). Accordingly, certain range-imaging systems may include an array of detection circuits 300, with each detection circuit 300 coupled to an associated photodiode.

The illustrated detection circuit 300 includes several transistors. For illustrative purposes, each transistor is a metal oxide semiconductor field effect transistor (MOSFET). Source, drain and gate terminals of each transistor are labeled “S”, “D” and “G”, respectively. One of ordinary skill in the art will recognize that other transistors or switching technologies also may be suitable to implement the disclosed techniques.

The detection circuit 300 includes four phase detectors 301a, 301b, 301c, 301d as well as a photodiode 302. A positive terminal (anode) of the photodiode 302 is electrically connected to ground potential. A negative terminal (cathode) of the photodiode 302 is electrically connected to an input terminal of an amplifier 304 and to a drain terminal on transistor 306. The output terminal of amplifier 304 is electrically connected to the gate terminal of transistor 306. A direct current power source, identified as VDD, is coupled to the source terminal of transistor 306.

Certain embodiments may include a current source (not shown) connected in parallel with the photodiode 302 to bias transistor 306 in such a manner that circuit response to incident light is rapid. This approach may, under certain conditions, add noise into the circuit.

Four multiplication transistors 308a, 308b, 308c and 308d are provided in the detection circuit. The illustrated embodiment shows PMOS transistors, however, other transistor types may be suitable as well. The gate terminals of each multiplication transistor 308a, 308b, 308c and 308d are connected to each other, connected to the gate terminal of transistor 306 and connected to the output terminal of amplifier 304.

A reference signal generator 206 is coupled to the detection circuit 300 for communication therewith. The illustrated reference signal generator 206 is adapted to generate four reference signals (including first, second, third and fourth reference signals) and to send each of those four reference signals to the detection circuit 300 over lines 302, 304, 306 and 308, respectively.

Each line 302, 304, 306 and 308 from the reference signal generator is coupled to a source terminal of an associated one of the multiplication transistors 308a, 308b, 308c, 308d. Each drain terminal of the multiplication transistors 308a, 308b, 308c, 308d, is electrically coupled to a source terminal of an associated buffering transistor 310a, 310b, 310c, 310d. The illustrated buffering transistors 310a, 310b, 310c, 310d are cascode transistors and are of the PMOS type. The gate terminals of each buffering transistor 310a, 310b, 310c, 310d are electrically connected to each other, to an external voltage source 313 and to a negative input terminal of amplifier 304. According to one implementation, the external voltage source 313 is a direct current (DC) power source.

Drain terminals of each buffering transistor 310a, 310b, 310c, 310d are electrically coupled to an associated capacitor 312a, 312b, 312c, 312d, and to a drain terminal of an associated output transistor 314a, 314b, 314c, 314d. The illustrated output transistors are NMOS type. According to one implementation, the capacitors may have capacitance values of approximately 50 femto-Farads. The source terminals of the output transistors 314a, 314b, 314c, 314d are electrically coupled to each other and to an external charge transimpedance amplification circuit (CTIA) 315. An output terminal of the CTIA 315 is electrically coupled to a processor 316 (which may be part of the computer 212 shown in FIG. 2). The processor 316 may be, for example, a digital computer and may include an analog to digital converter and associated software for processing data. Polling voltage sources (not shown) are coupled to each gate terminal of the output transistors 314a, 314b, 314c, 314d. The polling voltage sources are adapted to provide voltage at each gate terminal in such a manner that the output transistors 314a, 314b, 314c, 314d become conductive, one at a time, sequentially.

A reference signal generator 206 is coupled in communication with the detection circuit 300 via lines 318a, 318b, 318c, 318d. More specifically, each of the lines 318a, 318b, 318c, 318d is electrically connected to a source terminal of an associated multiplication transistor 308a, 308b 308c, 308d. The reference signal generator 206 is adapted to generate a reference signal on each of the lines 318a, 318b, 318c, 318d. Each of the reference signals may be a sinusoidal waveform. According to one embodiment, the first, second and third signals have the same frequency and have fixed phase relationships relative to each other. The frequency may be, for example, between approximately 1 megahertz and 50 megahertz. In some implementations, the frequency is between approximately 5 megahertz and 25 megahertz. In other implementations, the frequency is between approximately 10 megahertz and 20 megahertz. The fourth reference signal, however, may have a frequency that is lower than the frequency of the first, second and third reference signals. For example, the fourth reference signal may have a frequency that is between approximately 2% and 10% of the frequency associated with the first, second and/or third reference signals.

Functionally, the photodiode 302 is adapted to convert energy from incident light 310 into an electric current. In one implementation, the photodiode 302 converts a pulse (or flash) of incident light into an electric current pulse. The electric current pulse from the photodiode 302 charges the line connected to the output terminal of the photodiode 302. The amplifier 304 amplifies the voltage at the output terminal of the photodiode 302 to provide a gate voltage to the multiplication transistors 308a, 308b, 308c, 308d suitable to cause them to conduct. This amplification may desirably improve response time of the detection circuit 300, particularly when the strength of an incident light pulse on the photodiode 302 is low.

In relatively broad terms, an embodiment of a phase-detector (e.g., 301a) comprises a non-linear circuit element capable of combining an electric signal from a photodetector with a reference signal. The illustrated phase-detectors (e.g., 301a) indicate a phase relationship between the electric signal from the photodetector and the reference signal by implementing an analysis that approximates Fourier analysis. Other forms of analysis may be applied to render an indication of the phase relationship between the two signals. Generally, however, the output of such a circuit provides an indication of a phase relationship between electric signal and the reference signal.

The following description refers to one phase-detector (e.g., 301a in FIG. 3). It should be understood, however, that other phase detectors (e.g., 301b, 301c, 301d in FIG. 3) operate in a manner similar to phase-detector 301a. Once a sufficient voltage is applied to the gates of multiplication transistor 308a a drain current may begin to flow from the drain terminal of the multiplication transistor 308a. The drain current of the multiplication transistor may be defined by the following equation (equation #1):
I_{DRAIN}=α*I_{PULSE}*[1+V_{O} sin(2Πf_{C}t)]
where α is a proportionality factor, I_{PULSE} is the magnitude of the output current pulse from the photodiode, t is the delay of the light pulse return with respect to the reference signal (from line 318a), V_{O} is the amplitude of the reference signal (from line 318a) and f_{C} is the frequency of the reference signal (from line 318a). According to the above equation the drain current of multiplication transistor 308a is approximately proportional to the instantaneous value of the reference signal at the time of the light pulse's return to the photodiode 302. In instances where a current pulse from the photodiode is narrow (e.g., 20-40 ns) with respect to the frequency of the reference signal, then I_{DRAIN} may be approximately proportional to the product of the photodiode current and the reference signal. As the breadth of the photodiode current pulse increases, the sensitivity of the phase detector 301a decreases.

Drain current from the multiplication transistor 308a flows through an associated buffering transistor 310a and produces a charge on an associated capacitor 312a. The collection of charge on the capacitor represents an approximate integration of the drain current with respect to time. A voltage is thereby stored on the associated capacitor 312a and is indicative of a phase relationship between the light pulse incident upon the photodiode 302 and a reference signal from an associated reference signal generator line 318a. The buffering transistor 310a allows the capacitor 312a to charge without affecting the drain currents flowing out from the drain terminal of multiplication transistor 308a. Although the drain voltage of the buffering transistor 310a presumably increases as the associated capacitor 312a becomes charged, the drain voltage at the associated multiplication transistor 308a is not affected by that increase of stored charge. Accordingly, the drain current I_{DRAIN} from the multiplication transistor 308a may flow unhampered by the cumulating charge on the associated capacitor 312a. The charge that becomes stored on the capacitor represents an integration over time of the current that flows through the buffering transistor.

As mentioned above, a polling voltage source is connected to the gate terminal of output transistor 314a. The polling voltage source is adapted to provide voltage at the gate terminal in such a manner that permits the associated capacitor 312a to discharge to an output terminal of the detection circuit 300. Each capacitor 312a, 312b, 312c, 312d, is adapted to discharge one at a time, according to a sequence. For example, a polling voltage may be placed at the gate terminal of output transistor 314a causing that output transistor 314a to begin conducting. At the same time, each of the other output transistors 314b, 314c, 314d may be supplied a gate voltage that prevents them from conducting. Once capacitor 312a is discharged, the output transistor 314a may stop conducting and output transistor 314b may begin conducting to allow discharge of capacitor 312b.

When polled, a particular output transistor (e.g., 314a) may provide a conductive path for its associated capacitor 312a to discharge to an output terminal of the detection circuit 300. In the illustrated embodiment, the output terminal of the detection circuit 300 is connected to an external charge transimpedance amplifier (CTIA) 315. The CTIA 315 is adapted to convert the charge from the capacitor into a voltage that is suitable for further processing. According to one implementation, the CTIA 315 may be, for example, an operational amplifier that includes a capacitor in a feedback loop. The voltages generated by the CTIA 315 are approximately indicative of a phase relationship between the return pulse of light incident upon the photodiode 302 and a particular reference signal output from an associated output line 318a, 318b, 318c, 318d of the reference signal generator 206.

Each output transistor 314a, 314b, 314c, 314d is polled, one at a time, in a sequence. Accordingly, each of the voltages of capacitors 312a, 312b, 312c, 312d, is sequentially discharged, one at a time, into the CTIA 315. The CTIA 315 is adapted to convert the charges from each of these capacitors into a voltage that is approximately proportional to the associated capacitor voltage and that is suitable for further processing by the processor 316. According to the illustrated embodiment, in a single operational cycle, four voltages are generated by the CTIA 315, one voltage for each associated output transistor 314a, 314b, 314c, 314d.

In a particular embodiment, multiple detector circuits 300 may be provided in the form of an array having rows and/or columns. In that instance, an exemplary implementation may include one CTIA 315 associated with each column (or row) of the array. Appropriate switching and multiplexing circuitry may be provided to ensure that the outputs of each detector circuit 300 in that column (or row) are sent, one at a time, in a sequential manner, to the associated CTIA 315 for that column (or row). Alternatively, one CTIA 315 may be provided for an entire array of detector circuits 300. In that case, appropriate switching and multiplexing circuitry may be provided to ensure that the outputs of each detector circuit 300 in the array are sent, sequentially, one at a time, to the CTIA.

The output voltages generated by the CTIA 315 are sent to the processor 316, which includes circuitry for processing each of the CTIA 315 output voltages. Such processing may include determining a distance (“range”) between the light source 202 of the range-imaging system 200 and a target (e.g., 222), from which light was reflected. The circuitry in the processor may be adapted to determine the range by implementing, as an example, the following equation, which is based on Fourier transform theory (equation #2):

$$R = \frac{c}{4 π {f}_{c}} {tan}^{- 1} [ \frac{{m}_{1} - {m}_{2} ) + ( {m}_{1} - {m}_{3} )}{\sqrt{3} ( {m}_{2} - {m}_{3} )} ]$$

where m_{1,} m_{2,} and m₃ are outputs from the CTIA 315 corresponding to sequential capacitor discharges through output transistors 314a, 314b and 314c, respectively and where f_{C} is the frequency of the reference signal outputted from the reference signal generator 206 onto each of lines 318a, 318b and 318c. Depending on the particular embodiment, other equations may be used to calculate ranges. By differentially combining the resultant CTIA 315 outputs in this manner, distance may be determined largely independent of background illumination in the field of view, target albedo and common-mode noise. In certain instances, common-gate topology may suppress common-mode noise.

Ambiguities in distance calculations may exist due to the nature of equation #2. Specifically, equation #2 includes an arc tangent function, which has multiple values. One of the multiple values represents the actual (i.e.; “correct”) position (range). The other values correspond to phase shifts that are integer multiples of 360° displaced from the actual value. In order to resolve the phase ambiguity, a relatively low frequency reference signal may be generated by the reference signal generator 206 and sent to the detection circuit 300 via line 318d. Applying the low frequency reference signal on line 318d produces an associated output voltage from the CTIA 315 that indicates a coarse approximation of the distance from the light source 202 to a target (e.g., 222). Such coarse approximations of distance may be desirable in instances where ambiguity exists regarding a distance calculated using equation to resolve any ambiguity regarding a distance calculated using equation #2, above.

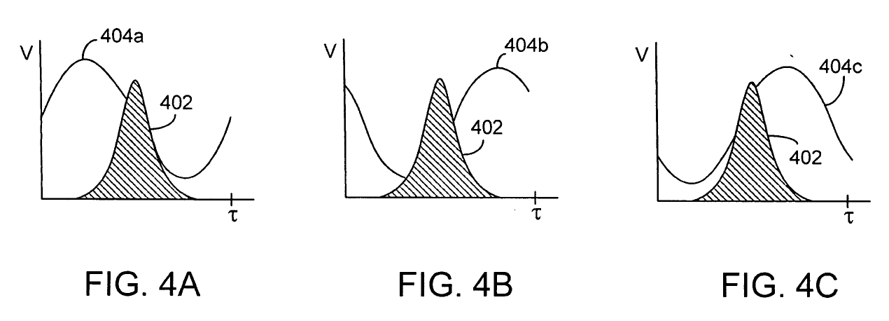

FIG. 4A-4C illustrate three sets of voltage waveforms, plotted against time (the horizontal axis in each waveform). Each set of voltage waveforms includes a gate voltage (“gate”) and a source voltage (“source”) of an associated one of the multiplication transistors 308a, 308b 308c (of FIG. 3), respectively. The waveforms illustrate that a different phase relationship exists between each gate voltage and each source voltage.

Each set of waveforms shows an output pulse 402 from a photodiode (e.g., photodiode 302 of FIG. 3) superimposed on a reference signal 404a, 404b, 404c (e.g., from one of lines 301a, 301b and 301c in FIG. 3, respectively). Referring first to FIG. 4A, the output pulse has a duration of approximately 40 nanoseconds. The reference signal has a frequency of approximately 10 MHz. The reference signals in each of FIGS. 4B and 4C also have frequencies that approximate 10 MHz. However, reference signal 404b is shifted approximately 120° relative to reference signal 404a. Reference signal 404c is shifted approximately 240° relative to the reference signal 404a. Visual inspection of each set of waveforms in FIGS. 4A-4C reveals that the output pulse 402 from the photodiode in each figure has a different phase relationship with each of the reference signals 404a, 404b and 404c illustrated.

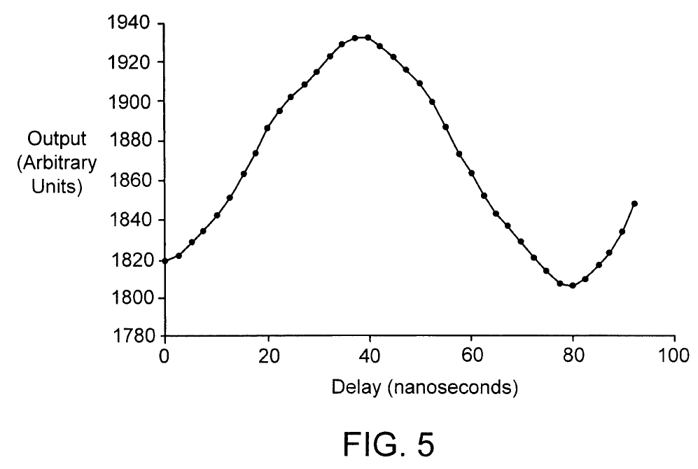

FIG. 5 illustrates results obtained by testing a circuit similar to the circuit illustrated in FIG. 3. During that test, a series of light pulses was applied to a photodiode (such as photodiode 302 in FIG. 3). Initial light pulses were applied in a manner such that the light pulse was delayed, relative to a reference signal (such as the reference signal input to transistor 308a in FIG. 3), by approximately 2.5 nanoseconds. The delay corresponding to subsequent applied light pulses was increased relative to the reference signal in increments of 2.5 nanoseconds. The charge from a single phase detector (e.g., phase detector 301a) was collected at an output terminal of the phase detector (e.g., at the source terminal of transistor 314a of FIG. 3).

Charge measurements are shown plotted against delay between the applied reference signal and the incident light pulse. Each measurement represented an incremental change in the delay of approximately 2.5 nanoseconds. Delay was varied from approximately 2.5 nanoseconds to over 80 nanoseconds. The charge measured at the output terminal of the phase detector varied approximately according to the delay of the incident light pulse relative to the reference signal. The measured charge approximately indicated a phase relationship between the light pulse and the associated reference signal at each delay.

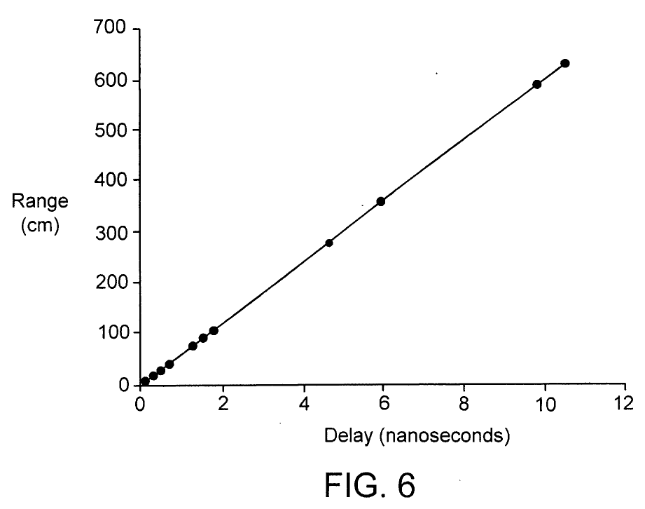

Referring now to FIG. 6, a series of light pulses was directed at an array of a circuit similar to the detection circuit 300 of FIG. 3. Reference signals having frequencies of approximately 20 MHz were applied to a detection circuit 300 over lines that correspond generally to lines 318a, 318b, 318c of FIG. 3. A reference signal having a frequency of approximately 2 MHz was applied to a detection circuit 300 over a line that corresponds generally to line 318d of FIG. 3. The delay between the reference signals and the incident light pulses was varied from approximately 0 nanoseconds to approximately 10 nanoseconds.

Data was collected from an output terminal of the detection circuit 300. The collected data was processed according to equation #2 (above) to determine a range associated with the collected output data. FIG. 6 illustrates a plot of the ranges (in centimeters) calculated according to the above equation #2 plotted against the delay (in nanoseconds) between the reference signals and the incident light pulses.

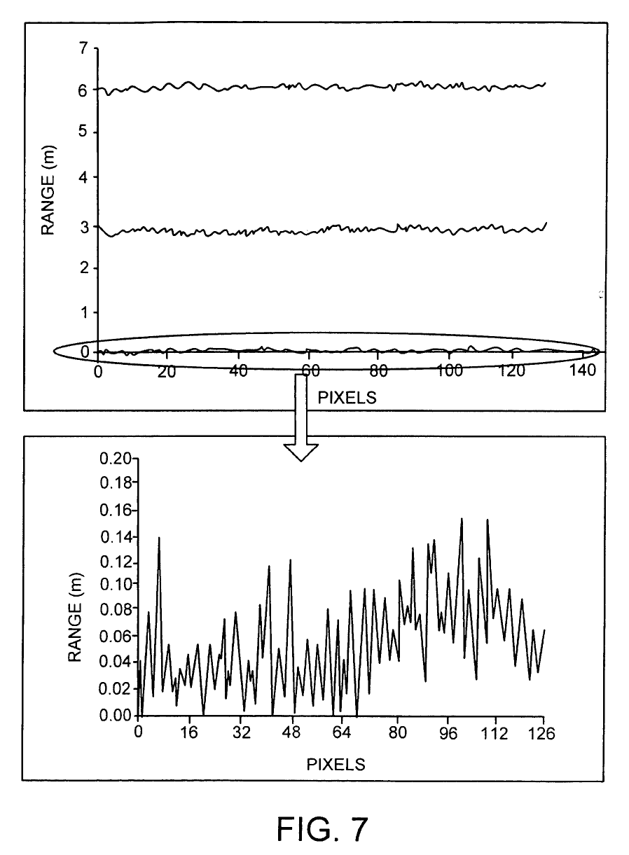

FIG. 7 illustrates two graphs. The lower graph is an enlarged view of the circled region in the upper graph. The upper graph shows the uniformity of calculated ranges by each of the 128 detection circuits and associated processing circuitry (e.g., CTIA 315 and processor 316). Three separate ranges are indicated. One range is approximately 6 meters, a second range is approximately 3 meters and a third range is less than approximately 2 centimeters. The lower graph of FIG. 7 indicates a close-up view of calculations from the third range. The illustrated graphs indicate substantial uniformity in range calculations for each of the detection circuits in the array.

Approximate characteristics for a particular detector array that was built follow. The array size was 128×1 arranged as one row (column) of detection circuits. The pixel (detection circuit) pitch was approximately 50 μm. The number of multiplication transistors per detection circuit was 4. The reference signal frequencies were 20 MHz and 1 MHz. The return pulse width was about 40 nanoseconds. The minimum detected current from the photodiode was about 0.85 nA. The minimum number of detected electrons was 210 e⁻. The minimum detectable range was less than 2 centimeters. The range depth was greater than 7 meters. The range non-uniformity was less than 2%. The repetition rate was greater than 100 Hz. The power dissipation was less than 30 mW.

A number of implementations have been described. Nevertheless, various modifications and applications of the concepts described herein may be made without departing from the spirit and scope of the invention. For example, various types of transistors or switching elements may be suitable for implementing the techniques described herein. Additionally, certain implementations may use a greater or lesser number of phase detector circuits. Various waveforms may be suitable for use as a reference voltage. In certain implementations it may not be desirable to apply a low frequency reference signal to the detector array for coarse distance estimation, as discussed above. Additionally, a particular detector circuit may only include a single phase detector. This may be appropriate, for example, where variations in the albedo of expected targets, detrimental effects of background illumination and electrical noise are expected to be minimum. Certain embodiments may not include an operational amplifier (such as 304 in FIG. 3) coupled to the output terminal of a photodiode. Photodiodes may be replaced, for example, by any device that is responsive to ambient light. Certain implementations may not require buffering transistors. Additionally, the suggested frequencies may be varied from application to application. Photodetectors, other than photodiodes, may be suitable, for example, for converting incident light into electric signals.

Accordingly, other implementations are within the scope of the following claims.

1. A method comprising:
transmitting light from a source into a field of view;
focusing return portions of the light, reflected off targets in the field of view, onto a two-dimensional array of photodetectors;
converting, with the photodetectors, the return portions of light into electric signals that are compatible with a solid state circuit; and
combining each electric signal with a first reference signal to indicate a distance between the source and an associated target.

2. The method of claim 1 wherein combining each electric signal with the first reference signal comprises multiplying each electric signal by the first reference signal and integrating a resulting product over time.

3. The method of claim 1 wherein the indicated distance is based on a first phase relationship between the return portions of the light and a first reference signal.

4. The method of claim 1 further comprising initiating generating the first reference signal at substantially the same time that the light is transmitted.

5. The method of claim 1 comprising calculating a distance between the source and each target based on the indicated distance.

6. The method of claim 5 comprising creating a map that represents the calculated distances between the source and each target in the field of view.

7. The method of claim 1 wherein indicating the distance between the source and each target comprises identifying a phase relationship between an electric signal from each photodetector and the first reference signal.

8. The method of claim 1 wherein determining the distance between the source and each target comprises generating a current that is proportional to a product of the electric signals and the first reference signal.

9. The method of claim 8 wherein determining the distance between the source and each target comprises integrating the current with respect to time.

10. The method of claim 9 wherein determining the distance between the source and each target comprises integrating the current with a capacitor.

11. The method of claim 1 wherein focusing the return portion of light includes passing the return portion of light through an optical lens coupled to the array of photodetectors.

12. The method of claim 1 comprising generating the first reference signal with an electronic oscillator.

13. The method of claim 1 comprising:
identifying a first phase relationship between a converted electric signal and the first reference signal;
identifying a second phase relationship between the converted electric signal and a second reference signal;
identifying a third phase relationship between the converted electric signal and a third reference signal; and
combining the first phase relationship, the second phase relationship and the third phase relationship to indicate a distance between an associated source and an associated target.

14. The method of claim 13 further comprising generating the first reference signal, the second reference signal and the third reference signal.

15. The method of claim 13 wherein the first reference signal, the second reference signal and the third reference signal are phase shifted relative to each other.

16. The method of claim 1 further comprising generating the light with a laser source.

17. The method of claim 1 further comprising generating the light with a light emitting diode.

18. The method of claim 1 further comprising diffusing the light into the field of view with an optical lens coupled to the source.

19. The method of claim 1 wherein the transmitted light is an optical pulse.

20. The method of claim 1 wherein the transmitted light has an intensity that varies according to a sinusoidal waveform.

21. The method of claim 1 wherein determining the distance between the source and each target is based on a phase relationship between the return portion of the light and a coarse-tuning reference signal, wherein the first reference signal is a periodic waveform having a first frequency and the coarse-tuning reference signal has a coarse-tuning frequency that is lower than the first frequency.

22. An apparatus comprising:
a light source adapted to transmit light into a field of view;
an optical receiver coupled to the light source adapted to receive return portions of the light, reflected off targets in the field of view; and
a solid state, two-dimensional array of detection circuits, wherein each detection circuit comprises:
a photodetector adapted to convert an associated return portion of light into an electric signal compatible with solid state circuitry; and
a solid state circuit comprising a phase detector adapted to combine the electric signal with a first reference signal to indicate a distance between the source and an associated target.

23. The apparatus of claim 22 wherein the distance indicated by each phase detector is based on a first phase relationship between the return portion of transmitted light and the first reference signal.

24. The apparatus of claim 22 wherein the optical receiver is adapted to focus each return portion of light onto an associated photodetector in the array of detection circuits.

25. The apparatus of claim 24 wherein each photodetector is adapted to convert a focused return portion of light into an electric signal that is compatible with the solid-state circuit.

26. The apparatus of claim 22 wherein each detector circuit comprises an amplifier coupled to an output terminal of the associated photodetector.

27. The apparatus of claim 22 wherein the apparatus comprises a reference signal generator adapted to generate the first reference signal.

28. The apparatus of claim 22 wherein each phase detector comprises a plurality of multiplication transistors coupled to an output terminal of an associated photodetector, wherein each of the plurality of multiplication transistors is adapted to receive an electric signal from the associated photodiode, wherein each multiplication transistor is adapted to receive the first reference signal, and wherein each multiplication transistor is adapted to output a current that is approximately proportional to a product of the associated electric signal and the first reference signal.

29. The apparatus of claim 28 wherein each phase detector comprises a plurality of capacitors, wherein each capacitor is coupled to an output terminal of an associated multiplication transistor, and wherein each capacitor is adapted to collect a charge that corresponds to an integration of an output signal from the associated multiplication transistor.

30. The apparatus of claim 22 comprising an electronic oscillator adapted to generate the first reference signal.

31. The apparatus of claim 22 wherein the phase detector is further adapted to:
identify a first phase relationship between a converted electric signal and the first reference signal;
identify a second phase relationship between the converted electric signal and a second reference signal;
identify a third phase relationship between the converted electric signal and a third reference signal; and
combine the first phase relationship, the second phase relationship and the third phase relationship to indicate a distance between the source and an associated target.

32. The apparatus of claim 31 further comprising an electronic oscillator adapted to generate the first reference signal, the second reference signal and the third reference signal.

33. The apparatus of claim 32 wherein the first reference signal, the second reference signal and the third reference signal are phase shifted relative to each other.

34. The apparatus of claim 22 wherein the solid-state circuitry comprises complementary metal oxide semiconductor (CMOS)-based circuitry.

35. The apparatus of claim 22 wherein the light source comprises a laser source.

36. The apparatus of claim 22 wherein the light source comprises a light emitting diode.

37. The apparatus of claim 22 comprising an optical lens coupled to the light source and adapted to diffuse the light transmitted into the field of view.

38. The apparatus of claim 22 wherein the light source is adapted to generate a light pulse.

39. The apparatus of claim 22 wherein the light source is adapted to generate a light having a sinusoidal waveform.

40. The apparatus of claim 22 comprising an operator interface adapted to display a map representing the distances between the source and each target in the field of view based on the indications from the phase detectors.

41. The apparatus of claim 22 comprising a coarse-tuning reference signal generator coupled to the detector array to generate a coarse-tuning signal for modulating a multiplication transistor.
